(19) United States
(12) Patent Application Publication
(10) Pub. No.: US 2025/0117606 A1
(43) Pub. Date: Apr. 10, 2025

(54) STORAGE MEDIUM STORING SPEECH TRANSLATION PROGRAM

(71) Applicant: SHIKUMI CO., LTD., Tokyo (JP)

(72) Inventor: Toshiyuki Kato, Saitama (JP)

(21) Appl. No.: 18/909,554

(22) Filed: Oct. 8, 2024

(30) Foreign Application Priority Data
Oct. 10, 2023 (JP) 2023-175389

(51) Int. Cl. G06F 40/58; G06T 13/20; G06T 13/40; G10L 13/047; G10L 15/30

(52) U.S. Cl. CPC G06F 40/58; G06T 13/205; G06T 13/40; G10L 13/047; G10L 15/30

(57) ABSTRACT

A storage medium storing a speech translation program according to the present invention is a storage medium storing a speech translation program executed on a portable information terminal, wherein the speech translation program causes a control unit of the information terminal to execute steps of: recognizing inputted speaker's speech and outputting information on a recognition result; translating a language spoken by the speaker into another language based on the output information on the recognition result, and outputting information on a result of translation; performing speech synthesis of words in the other language based on the output information on the result of translation in a way that enables the words to be played back in a voice that resembles the speaker's own voice; and playing back the words in the other language in the voice that resembles the speaker's own voice by the speech synthesis.

### CROSS-REFERENCE TO RELATED APPLICATION

This patent application claims the benefit and priority of the Japanese Patent Application No. 2023-175389, filed with the Japanese Patent Office on Oct. 10, 2023, the disclosure of which is incorporated by reference herein in its entirety as part of the present application.

### FIELD OF THE INVENTION

This invention relates to a storage medium storing a speech translation program, and in particular, to a storage medium storing a speech translation program that can facilitate communication between people having a conversation.

### BACKGROUND

In recent years, with the advance of globalization, cross-border and overseas activities have increased the number of in various industries and fields, including business. On the individual level, the number of overseas tourists for sightseeing and other purposes has increased worldwide. In overseas activities and travel, people need to communicate in different languages, but it is still difficult for people from different countries to communicate adequately with each other, as many people are not comfortable with foreign languages.

An example of a convenient speech translation device that can help people from different countries communicate with each other is disclosed, for example, in Japanese Patent Laid-Open No. 2004-212685. This conventional speech translation device recognizes speaker's speech, for example, in Japanese, input via a microphone. The recognized Japanese speech is converted into, for example, English speech. Then, the device has a function to output the converted English speech from a speaker. By using this speech translation device, even Japanese people who are not good at English, for example, can easily communicate with English-speaking foreigners.

However, although conventional speech translation devices enable communication with foreigners who speak different languages through their speech translation functions, speech output by the speakers of the devices is faltering and has monotonous intonation, and thus sounds unnatural. Furthermore, speech output by those speech translation devices is immediately recognizable as synthesized speech, quite different from speaker's voice, and a hearer may feel odd during a conversation due to the difference between the speaker's own voice that is heard directly by the hearer and the voice produced by the speech translation devices. For this reason, with conventional speech translation devices, conversations are limited to simple ones, for example, including just a single question such as “Where is the station?” Thus, even if there is something to talk more about or to ask more about, conversations will not be lively and cannot be sustained, and as a result, communication among those having the conversations is not facilitated.

### SUMMARY OF THE INVENTION

Embodiments of the present invention, which can help to solve the above-described problem(s), is to provide means for facilitating communication between people having a conversation.

A storage medium storing a speech translation program according to one aspect is a storage medium storing a speech translation program executed on a portable information terminal, wherein the speech translation program causes a control unit of the information terminal to execute steps of: recognizing inputted speaker's speech and outputting information on a recognition result; translating a language spoken by the speaker into another language based on the output information on the recognition result, and outputting information on a result of translation; performing speech synthesis of words in the other language based on the output information on the result of translation in a way that enables the words to be played back in a voice that resembles the speaker's own voice; and playing back the words in the other language in the voice that resembles the speaker's own voice by the speech synthesis.

The storage medium storing a speech translation program according to the present invention can provide means for facilitating communication between people having a conversation. The present summary is provided only by way of example and not limitation. Other aspects of the present invention will be appreciated in view of the entirety of the present disclosure, including the entire text, claims, and accompanying figures.

### BRIEF DESCRIPTION OF THE DRAWINGS

FIG. 1 is a block diagram illustrating a hardware configuration of a mobile terminal;

FIG. 2 is a software module configuration diagram of the speech translation program;

FIG. 3 is a diagram illustrating a network configuration of a mobile terminal and servers for speech translation;

FIG. 4 is a flowchart illustrating the flow of a speech translation process on a mobile terminal;

FIG. 5 is a sequence diagram illustrating interactions between a mobile terminal and servers for speech translation (when a translation server is specified); and

FIG. 6 is a sequence diagram illustrating interactions between a mobile terminal and servers for speech translation (when no translation server is specified).

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION OF THE INVENTION

The following describes an embodiment of the present invention with reference to accompanying drawings.

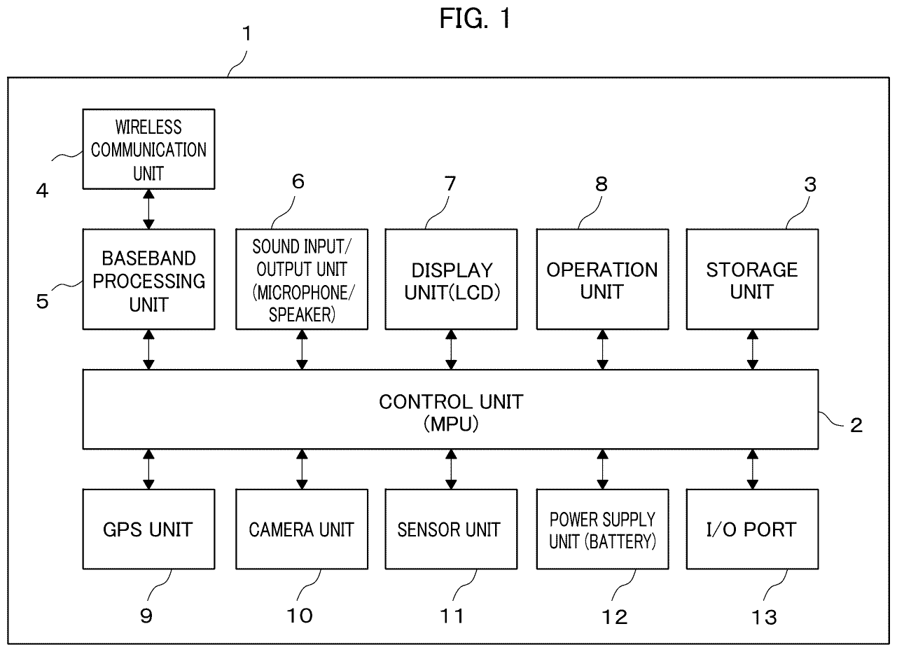

FIG. 1 is a block diagram illustrating a hardware configuration of a mobile terminal 1 according to one embodiment of the present invention. The mobile terminal 1 in this embodiment is a portable information terminal, such as a smartphone, that can be carried around. The speech translation program according to the present invention corresponds to application software to be installed and operated on the mobile terminal 1, and is a program with a function to translate, for example, Japanese words spoken by a speaker into English, and to play back the translated English words in a voice that resembles the speaker's voice.

The mobile terminal 1 in this embodiment includes a control unit 2, a storage unit 3, a wireless communication unit 4, a baseband processing unit 5, a sound input/output unit 6, a display unit 7, and an operation unit 8.

The control unit 2 has a Micro Processing Unit (MPU) and executes programs such as a given basic operating system (OS) and middleware. By executing these programs, the control unit 2 controls any part of the mobile terminal 1, creates a native platform environment and an application execution environment on the software configuration, and also performs various processes necessary for the mobile terminal 1.

The storage unit 3 includes a Random Access Memory (RAM) as its volatile memory and an internal memory storage, so-called Read Only Memory (ROM), as its non-volatile memory. In this storage unit 3, a dynamic RAM and the like is used as its RAM and a flash memory and the like is used as its ROM. The storage unit 3 stores in the ROM an operating system program that controls the mobile terminal 1, driver programs used for processing in any part of the mobile terminal 1, and an application program for speech translation. Accordingly, the ROM corresponds to a storage medium storing a speech translation program. In particular, the storage unit 3 stores, for example, a basic OS such as Android® OS and iOS®, as the operating system program. In addition, the storage unit 3 stores various text data, audio data, image data, etc., and temporarily stores in the RAM operation result data generated in the process of operations of predetermined processing executed by the control unit 2.

The wireless communication unit (external communication unit) 4 functions as wireless LAN communication means that communicates via a wireless LAN access point and mobile communication means that communicates via a cellular communication base station, and includes a synthesizer, frequency converter, high-frequency amplifier, and antenna, for example. The wireless communication unit 4 performs high-frequency signal processing for wireless communication with access points in accordance with a predetermined wireless LAN communication standard such as IEEE 802.11. In addition, the wireless communication unit 4 performs high-frequency signal processing for wireless communication with base stations in accordance with a predetermined cellular communication standard such as 3G, Long Term Evolution (LTE), and the 5th generation mobile phone system (5G).

The baseband processing unit 5 executes digital signal processing for voice and data communication with other communication terminals such as cell phones and various servers. This baseband processing unit 5 is connected to the above-mentioned wireless communication unit 4 via a D/A converter and an A/D converter.

The sound input/output unit 6 includes a microphone, speaker, and signal processing circuit. The sound input/output unit 6 converts an analog signal of voice input via the microphone into a digital signal using the signal processing circuit, and outputs the digital signal to the control unit 2 and the baseband processing unit 5. The sound input/output unit 6 converts a digital signal input by the control unit 2 and the baseband processing unit 5 into an analog signal using the signal processing circuit, and outputs the analog signal to the speaker. The speaker outputs a voice, sound effect that indicates incoming mail, for example, and music to the outside based on this analog signal input.

The display unit 7 includes a liquid crystal display or an organic Electro-Luminescence (EL) display, and displays various images based on instructions from the control unit 2.

The operation unit 8 includes a touch panel incorporated in the display unit 7, various operation buttons provided on the mobile terminal 1, and a power switch as means for turning on/off the power. The operation unit 8 is used by a user to turn on/off the power of the mobile terminal 1, start and close applications, select menus, switch screens, change settings necessary for various software operations, and enter textual information.

The mobile terminal 1 also includes a Global Positioning System (GPS) unit 9 to acquire position information, a camera unit 10 to capture images, a sensor unit 11, a power supply unit 12 to supply power to any part of the mobile terminal 1, an I/O port 13, and a clock unit not shown in the figure.

The GPS unit 9 includes a GPS receiver module and a GPS antenna, receives radio waves (positioning signals) from multiple GPS satellites located around the Earth, and calculates data regarding the latitude, longitude, and altitude of the current position of the mobile terminal 1 based on the reception results.

The camera unit 10 includes lenses and an imaging device, and is used to take pictures of people, scenery, etc. A Charge Coupled Device (CCD) image sensor or a CMOS image sensor is used as the imaging device.

The sensor unit 11 has, for example, an accelerometer, gyro sensor, and geomagnetic sensor. Based on the output of the sensor unit 11, data on the position, orientation, posture, and motion of the mobile terminal 1 can be calculated.

The power supply unit 12 includes a rechargeable battery, a power supply circuit that converts the output of the battery to power at a given voltage and supplies it to any part of the mobile terminal 1, and a charging circuit for charging the battery.

The I/O port (external communication unit) 13 is mainly a port for connecting cables with connectors in conformance to the Universal Serial Bus (USB) Type-C (TM) or Lightning (TM) standard. The control unit 2 can send and receive data to and from external devices via cables connected to this I/O port 13 using those connectors. The battery of the mobile terminal 1 can also be charged by supplying power externally via a cable connected to this I/O port 13. In this case, power supplied externally via the cable is transmitted to the charging circuit of the power supply unit 12. The charging circuit uses the power to charge the battery.

The clock unit not shown in the figure includes a clock circuit, keeps the correct date and time, and generates time information for various information update processes.

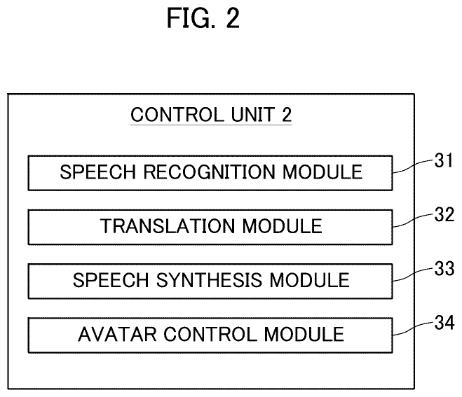

The module configuration of the speech translation program as application software executed by the control unit 2 of the mobile terminal 1 is now described with reference to FIG. 2.

As shown in FIG. 2, the speech translation program in this embodiment mainly includes a speech recognition module 31, a translation module 32, a speech synthesis module 33, and an avatar control module 34.

The speech recognition module 31 is a software module that recognizes words spoken by a speaker from the digital signal (speech data) of the speaker's speech, which is input via the microphone and converted by the sound input/output unit 6, and outputs the recognition result as text data. The speech recognition module 31 uses a speech recognition function provided by an Internet server as a cloud service in view of future evolution of speech recognition in terms of recognition accuracy and speed, and in order to reduce the load on the mobile terminal from execution of the speech translation program.

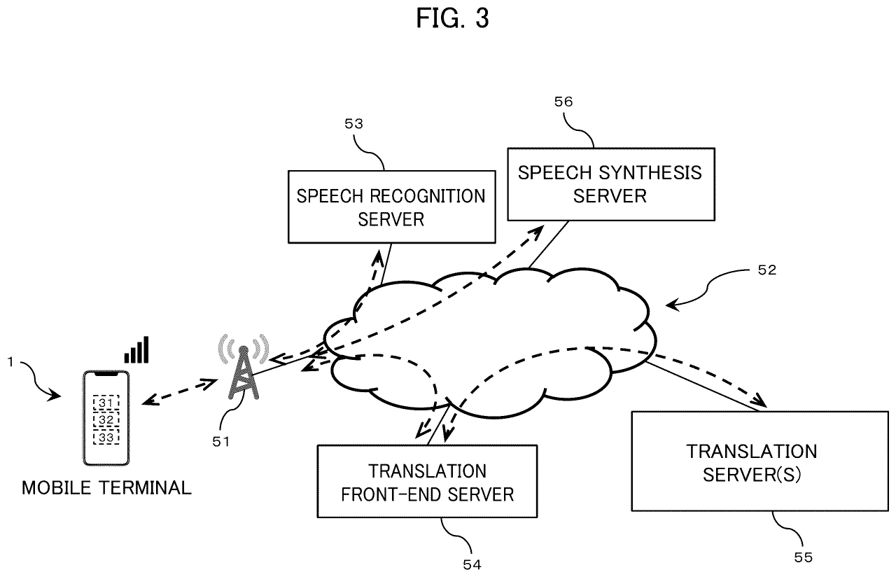

Specifically, any of the speech recognition functions provided by, for example, Microsoft® Corporation, Google® LLC, and Amazon®.com, Inc. is used by way of their Speech To Text APIs. In this case, as shown in FIG. 3, the speech recognition module 31 uses the speech recognition function by communicating with a speech recognition server 53 connected to the Internet 52 via wireless communication with, for example, a base station 51 through the baseband processing unit and the wireless communication unit of the mobile terminal 1.

For the use of the speech recognition function, REpresentational State Transfer (REST) Application

Programming Interface (APIs) can be used, but it is preferable to use API provided in software development kit (SDKs) distributed by various companies. Speaker's speech data, which is output by the sound input/output unit 6 after input via the microphone, is passed to these APIs, and text data is received from via the APIs as the result of speech recognition returned from servers of those companies. In other words, by using the APIs in this way, the speech recognition module 31 utilizes an external server to recognize speaker's speech, and then receives the recognition result from the server and outputs text data as the result of speech recognition. A REST API is an API that performs external invocation procedures to use World

Wide Web (WWW) systems/services using HyperText Transfer Protocol (HTTP).

The translation module 32 is a software module that translates the text data of a speech recognition result output by the speech recognition module 31 into another language and outputs the translated text data as the result of translation. The translation module 32 uses a language translation function(s) provided as a cloud service(s) in view of future evolution of language translation in terms of translation accuracy and speed, and in order to reduce the load on the mobile terminal from execution of the speech translation program. Specifically, any of the language translation functions provided by, for example, Microsoft Corporation, Google LLC, Amazon. com, Inc. and DeepL SE is/are used.

The translation module 32 uses a language translation function(s) provided by an external translation server(s) 55 by communicating with a translation front-end server 54 connected to the Internet 52 via wireless communication with, for example, the base station 51 of the mobile terminal 1, as shown in FIG. 3. In other words, the translation module 32 uses a language translation function(s) provided as a cloud service(s) by the translation server(s) 55 connected to the Internet 52 via the translation front-end server 54. In this case, the translation module 32 exchanges information with the translation front-end server 54 via a proprietary designed API.

Specifically, the translation module 32 passes the text data of a speech recognition result from the speech recognition module 31 to the translation front-end server 54 through the proprietary API as request data for translation into another language. Subsequently, the translation module 32 receives text data as the result of translation from the translation front-end server 54 via the proprietary API. Although it is a proprietary designed API, in the API, a speaker, as a user of the speech translation program, can specify which language translation function to use from among language translation functions provided by different companies, for example, based on which language translation function provides most reliable results. If a speaker does not specify which language translation function to use, the language translation function of the server that returns a result of translation first in response to a translation request, among language translation functions provided by servers of various companies, is used. In this case, as the result of translation, the result of translation returned first from the server is used. This is because, at present, there is not much difference in translation accuracy between language translation functions provided by various companies, except in the case of translating special terms used in the medical field, for example, and thus the speed of translation has more importance.

In this way, the translation module 32 uses a language translation function(s) provided by the external translation server(s) 55 with the translation front-end server 54 serving as a proxy. The advantages of this configuration include, for example, centralized control of the translation process when multiple language translation services are used, and the ability to manage the addition, change, and deletion of language translation service providers separately from the speech translation program. In this case, the speech translation program can also simplify the process of using language translation services. In addition, obviously, since the processing related to the process is executed on the translation front-end server 54 side, the load caused by execution of the speech translation program can be reduced on the mobile terminal running the speech translation program.

In the translation front-end server 54, for the use of the language translation function(s) provided by the external server(s), REST APIs can be used as in the above-mentioned case of using the speech recognition function. If the companies that provide language translation functions distribute SDKs, it is preferable to use APIs provided by the SDKs. The translation front-end server 54 passes text data to be translated to these APIs, and receives text data via the APIs as the result of translation into another language returned from servers of those companies.

In particular, the translation front-end server 54 determines the translation server(s) to which a translation request is made (i.e., service provider) based on information regarding the specified provider of a language translation service (language translation function) received via the proprietary API from the translation module 32 of the mobile terminal 1. In this determination, if any provider is specified in the information regarding the specified provider of a language translation service, the translation server corresponding to the specified provider is determined as the translation server to which the translation request is made. In contrast, if no provider is specified in the information regarding the specified provider, all the translation servers managed as available servers on the translation front-end server 54 at the time are determined as the translation servers to which the translation request is made. Then, the translation front-end server 54 passes the text data to be translated to the above API(s) corresponding to the determined translation server(s) to which the translation request is made. Subsequently, when the result(s) of translation into another language is returned from the translation server(s), the translation front-end server 54 receives the text data of the result of translation via the API.

When the result of translation is received, if no provider is specified in the information regarding the specified provider of a language translation service, the results of translation are returned from all the translation servers to which the translation request is made, as described above. In this case, as mentioned above, the result of translation returned first in response to the translation request among those results of translation is used as the result of translation, and thus the translation front-end server 54 receives the text data of the result of translation returned first from the servers via the API.

By using the API(s) in this way, when text data of a speech recognition result is passed from the translation module 32 via the proprietary API, the translation front-end server 54 utilizes the external server(s) to translate the text data into another language. When the translation front-end server 54 receives the text data of the result of translation into the other language returned from an external server, the translation front-end server 54 returns the text data to the translation module 32 as the result of translation via the proprietary API.

The speech synthesis module 33 is a software module that synthesizes speech in another language based on a result of translation output by the translation module 32, i.e., the text data of a result of translation of speaker's words into the other language, and outputs speech data (digital signal) of the synthesis result. The speech synthesis module 33 uses a speech synthesis function provided as a cloud service in view of future evolution of speech synthesis in terms of the quality of synthesized speech and the synthesis speed, and in order to reduce the load on the mobile terminal from execution of the speech translation program. Specifically, any of the speech synthesis functions provided by, for example, Microsoft Corporation, Google LLC, and Amazon. com, Inc. is used by way of their Text To Speech (TTS) APIs. In this case, as shown in FIG. 3, the speech synthesis module 33 communicates with a speech synthesis server 56 connected to the Internet 52 via wireless communication with, for example, the base station 51 by the mobile terminal 1 to use the speech synthesis function of the speech synthesis server 56.

For the use of the speech synthesis function, REST APIs can be used, but it is preferable to use APIs provided in SDKs distributed by various companies. The text data of a result of translation of speaker's words into another language is passed to these APIs, and speech data is received via the APIs as the result of speech synthesis returned from servers of those companies. In other words, by using the API in this way, the speech synthesis module 33 utilizes an external server to synthesize speech for the text data of translated speaker's words in another language, i.e., a result of translation output by the translation module 32. The speech synthesis module 33 then receives the result of speech synthesis (speech data) from the server and outputs the speech data (digital signal) as the speech synthesis result.

When the speech translation program in this embodiment synthesizes speech for translated words (text data) in another language, it is also possible to synthesize the speech so that the translated words are played back and output from the speaker in a voice that resembles the speaker's own voice. That is, the speech translation program has a function to play back the translated words in a voice that resembles the speaker's own voice. This function can be used by a user of the speech translation program, as a speaker, setting this function to “Enabled” in the settings screen of the mobile terminal, for example. When this function is enabled, the speech synthesis module 33 refers to the model ID of a custom voice for the speaker in a TTS API call when the speech synthesis function provided as a cloud service by, for example, Google LLC, is used. This enables the speech translation program to play back the translated words in a voice that resembles the speaker's own voice.

Google LLC's custom voice model is created by preparing speech data in the speaker's own voice recorded in advance, and then performing training (machine-learning) on the speech data beforehand on a cloud server. For example, to learn a Japanese voice, the user must prepare speech data by recording the user's reading in the user's own voice of about 500 Japanese sentences (scripts) provided by Google LLC, such as “ [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] (Please take some pictures of a stationary object in a well-lighted place.).”

The speech synthesis module 33 usually uses a speech synthesis function provided by an Internet server as a cloud service for the reasons mentioned above. However, when the above-described function is enabled to play back the translated words in a voice that resembles the speaker's own voice, it is not very desirable to use a speech synthesis function provided as a cloud service from the perspective of security, such as for preventing impersonation of the speaker using the voice.

For this reason, the speech translation program in this embodiment has a user-selectable option to use, when the above-described function is enabled, the speech synthesis function of the mobile terminal 1 itself to play back and output the translated words in a voice similar to the speaker's own voice and output them from the speaker. This selection is made by the user setting the speech synthesis function of the mobile terminal 1 itself to “Enabled” in the settings screen of the mobile terminal 1, for example.

Specifically, when this option is used, a user of the speech translation program reads a specified sentences into the microphone of the mobile terminal 1 in advance, and the mobile terminal 1 learns characteristics of the user's voice in the reading and creates a voice model of the user as a result of this learning. If the OS of the mobile terminal 1 is iOS, for example, then using its Personal Voice function, the user reads randomly selected text displayed on the display unit 7 into the microphone of the mobile terminal 1, and the mobile terminal 1 learns characteristics of the user's voice. For example, to learn an English voice, the display unit 7 displays text such as “Grabbing a cup of coffee this afternoon sounds great.” and the user reads the text. Through this learning (machine learning), a voice model of the user is created on the mobile terminal 1. Then, the speech synthesis module 33 of the speech translation program performs speech synthesis by specifying, in an iOS API call, text data translated into another language by the translation module 32 and the name of the voice model of the user created as described above. In this case, as the API, the API provided by the iOS Speech synthesis framework is used.

This allows the speech translation program to use the voice model of the user created by the mobile terminal 1 for synthesizing speech for the words of the text data translated into the other language on the mobile terminal 1, and to play back the translated words in a voice that resembles the user's own voice. At the time of filing of this application, as ios, ios 17 is used.

The avatar control module 34 is a software module that displays an avatar as user's alter ego on the screen of the display unit 7 according to the option selected by the user and controls the movements, facial expressions, mouth movements, etc. of the avatar. This selection is made by the user setting avatar display to “ON” (the avatar is displayed) or “OFF” (the avatar is not displayed) in the settings screen of the mobile terminal 1, for example. When avatar display is set to “ON” (the avatar is displayed), for example, the avatar to be displayed can be selected from among multiple avatars on the same settings screen. The avatar control module 34 uses a game engine such as Unity™, for example, to control the movements, facial expressions, mouth movements, etc. of the avatar.

The speech translation program in this embodiment uses, in particular, an asset (plug-in program) for lip-sync in order to synchronize the mouth movements of the avatar with the playback of speech synthesized by the speech synthesis module 33, i.e., reading of words. For example, as the asset, uLipsync is used, which is a Unity plug-in to perform lip-sync processing by identifying vowels and consonants by capturing characteristics of phonemes based on Mel-Frequency Cepstrum Coefficients

(MFCCs). The model data of an avatar is imported into Unity, for example, in the VRM file format for virtual reality (VR) applications.

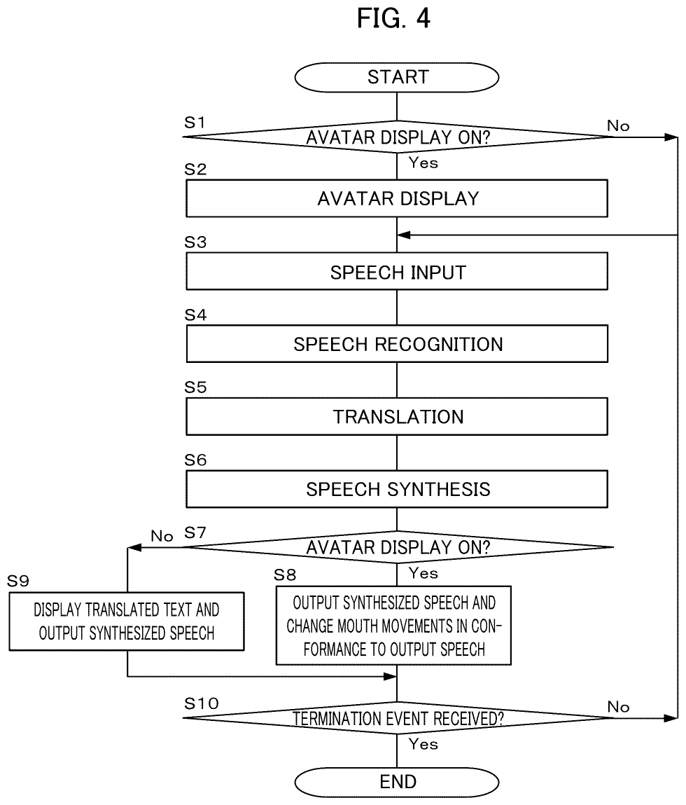

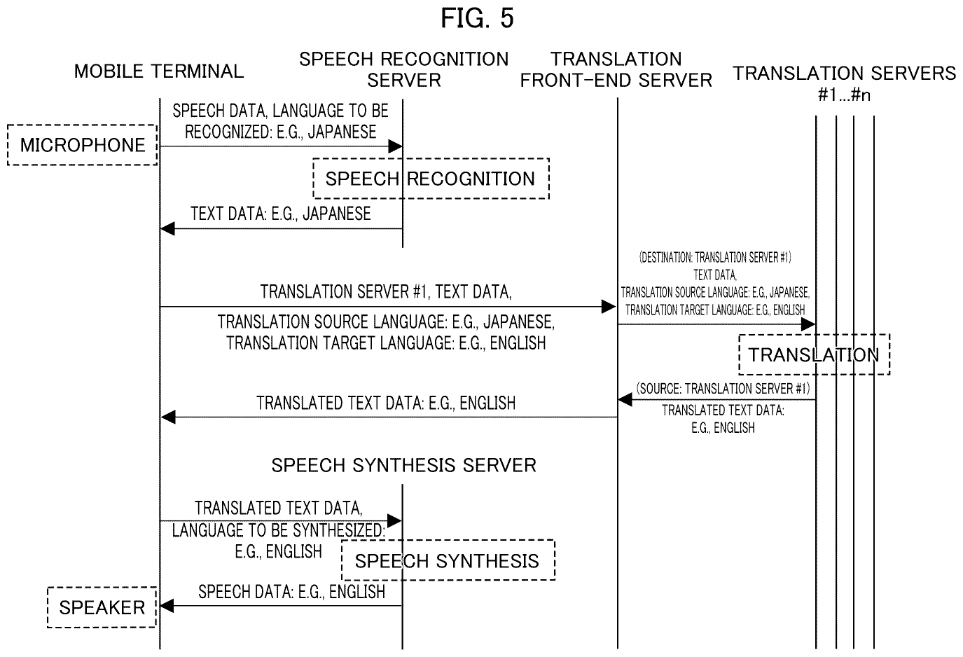

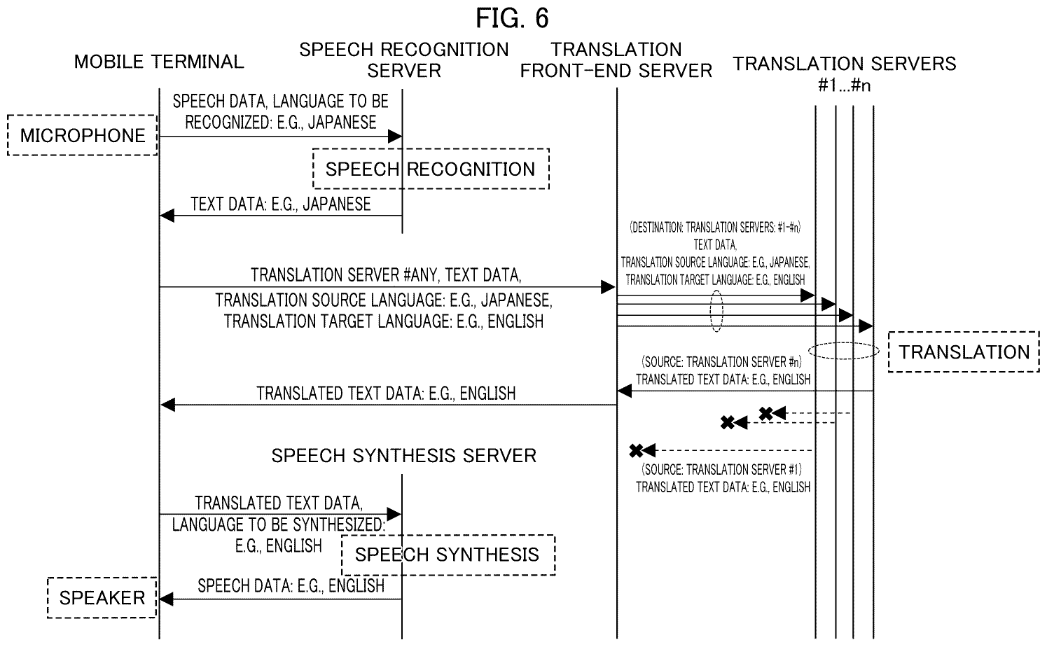

A speech translation process performed by the speech translation program in this embodiment is described below in reference to the flowchart in FIG. 4 and the sequence diagrams in FIGS. 5 and 6. The process of the flowchart in FIG. 4 is executed by the control unit 2, for example, when a user taps the icon of the speech translation program displayed on the home screen of the mobile terminal 1 to start the program (application). In step S1, the control unit 2 determines whether avatar display is set to “ON” or not. Then, if avatar display is set to “ON,” the control unit 2 proceeds to step S2 (Yes branch), or if avatar display is not set to “ON” (i.e., is set to “OFF”), the control unit 2 proceeds to step S3 (No branch).

In step S2, by executing the program of the avatar control module 34, the control unit 2 displays an avatar on the screen of the display unit 7. In doing so, if an avatar has been selected by the user, the selected avatar is displayed on the screen; if not, the avatar that should be displayed in that case is displayed.

In step S3, when the speaker's speech is inputted via the microphone, the analog signal from the microphone is converted by the sound input/output unit 6 to a digital signal (speech data), and the control unit 2 obtains the speech data.

In step S4, by executing the program of the speech recognition module 31, the control unit 2 passes the speech data to the API to use the speech recognition function, thereby utilizing an external server to recognize the speaker's voice. The control unit 2 then receives the text data of the recognition result returned by the server via the API. When speech data is passed to the API, information on the language code corresponding to the source language (e.g., Japanese) for language translation, which is set in advance by the user, is also passed to the API together with the language to be recognized for speech recognition. As the information on the language code, a language code conforming to the international standard ISO-639-1 or BCP-47 (e.g., “ja-JP” for Japanese) is used. The source language for language translation and the target language for translation, described later, are set by the user, for example, via the settings screen of the mobile terminal 1.

When the control unit 2 receives the text data of the recognition result via the API, the control unit 2 outputs the text data as the result of speech recognition. This output is inputted to the translation module 32.

In step S5, by executing the program of translation module 32, the control unit 2 passes the text data of the speech recognition result to the translation front-end server 54 through the proprietary API as request data for translation into another language. In doing so, the above-mentioned information regarding the specified provider is also passed to the translation front-end server 54 through the proprietary API. This information regarding the specified provider for specifying the translation server to which a translation request is made (i.e., service provider) can be specified (set) by the user, for example, on the settings screen of the mobile terminal 1, by selecting a language translation service (language translation function) that the user wants to use for translation from among one or more translation services displayed on the screen. In the initial state where this specification has not been done yet, information indicating “unspecified” is set in this information regarding the specified provider.

After the translation front-end server 54 receives those pieces of information, the translation front-end server 54 uses a language translation function(s) provided by external server(s) to perform translation into the other language. When a translation request is made to the translation front-end server 54 using the proprietary API, information on the language codes corresponding to the source language (e.g., Japanese) and the target language (e.g., English) for language translation, which are set in advance by the user, is also passed via the API. As the information on the language codes, language codes conforming to the above-mentioned international standard (e.g., “ja-JP” for Japanese and “en-US” for English/US) are used.

As described above, the translation front-end server 54 determines the translation server(s) to which a translation request is made (i.e., service provider) based on the information regarding the specified provider of a language translation service received via the proprietary API from the translation module 32 of the mobile terminal 1. If any provider is specified in the information regarding the specified provider, the translation server corresponding to the specified provider is determined as the translation server to which the translation request is made, or if no provider is specified, all the translation servers managed as available servers on the translation front-end server 54 are determined as the translation servers to which the translation request is made. Then, the translation front-end server 54 passes the text data to be translated to the API(s) corresponding to the determined translation server(s) to which the translation request is made. In doing so, the above-described information on the language codes (e.g., “ja-JP” for Japanese and “en-US” for English/US) corresponding to the translation source language (e.g., Japanese) and the translation target language (e.g., English) received via the proprietary API is also passed to the API(s) corresponding to the translation server(s) to which the translation request is made.

Subsequently, when the result(s) of translation into the other language is returned from the translation server(s) to which the translation request is made, the translation front-end server 54 receives the text data of the result of translation via the API. When the result of translation is received, if no provider is specified in the information regarding the specified provider, the results of translation are returned from all the translation servers to which the translation request is made, and the translation front-end server 54 receives the text data of the result of translation via the API returned first in response to the translation request. In this regard, in particular, FIG. 5 illustrates the case where some provider is specified in the information regarding the specified provider, and a sequence diagram in FIG. 6 illustrates the case where no provider is specified in the information regarding the specified provider. When the translation front-end server 54 receives the text data of the result of translation into the other language returned from an external server, the translation front-end server 54 returns the text data to the control unit 2 executing the translation module 32 as the result of translation via the proprietary API.

When the control unit 2 receives the text data as the result of translation into the other language from the translation front-end server 54 via the proprietary API, the control unit 2 outputs the text data as the result of translation. This output is inputted to the speech synthesis module 33.

In step S6, by executing the program of the speech synthesis module 33, the control unit 2 passes the text data of the result of translation to the API to use the speech synthesis function, thereby utilizing an external server to synthesize speech for the translated speaker's words in the other language. The control unit 2 then receives the speech data of the synthesis result returned by the server via the API. When the text data of the result of translation is passed to the API, information on the language code (e.g., “en-US”) corresponding to the target language (e.g., English/US) for language translation, which is set in advance by the user, is also passed to the API as the language to be synthesized for speech synthesis.

As described above, the speech translation program in this embodiment has a function to play back the translated words in a voice that resembles the user's own voice. When this function is enabled, in execution of the speech synthesis module 33, the control unit 2 refers to the model ID of a custom voice for the speaker in an API call to use a speech synthesis function of a cloud service, and thereby has the server that provides the service perform speech synthesis. In this case, the control unit 2 receives the speech data of the synthesis result returned by the server via the API.

Alternatively, if the speech synthesis function provided by the mobile terminal itself is used for this function, in execution of the speech synthesis module 33, the control unit 2 calls the iOS API in the case of ios, for example. In this case, the control unit 2 specifies the name of a voice model of the user created on the mobile terminal 1 by prior learning in the iOS API call, and thereby performs speech synthesis only on the mobile terminal 1. The speech synthesis on the cloud or mobile terminal is performed using a voice model corresponding to the target language (e.g., English/US) for language translation set in advance by the user.

In step S7, the control unit 2 determines whether avatar display is set to “ON” or not. Then, if avatar display is set to “ON,” the control unit 2 proceeds to step S8 (Yes branch), or if avatar display is not set to “ON” (i.e., is set to “OFF”), the control unit 2 proceeds to step S9 (No branch).

In step S8, by executing the program of the avatar control module 34, the control unit 2 controls the movements, facial expressions, mouth movements, etc. of the avatar displayed on the screen of the display unit 7, and plays back the speech data of the synthesis result received via the API by the sound input/output unit 6 and outputs the speech from the speaker. More specifically, in controlling the avatar, the control unit 2 creates an audio file (e.g., in .WAV format) that records the speech data of the synthesis result, and operates Unity to play back the speech using this file. This executes the lip-sync processing by uLipsync, which is a Unity plug-in. In this lip-sync processing, uLipsync analyzes the waveform of the speech being played back and changes the mouth movements of the avatar so as to conform the mouth shape to the result of the analysis, and therefore, in this case, the translated speech (words) can be played back as if the avatar were speaking, although this is just a subjective evaluation. In other words, this lip-sync processing changes the mouth movements of the avatar to match the timing of speech by playing back the translated words (speech) and to conform the mouth shape to the content of the speech.

When the above-described function to play back the translated words in a voice similar to the use's own voice (using the speech synthesis function provided by the mobile terminal itself, for example, the speech synthesis function of iOS) is used, the control unit 2 performs a process described below instead of the process above. In view of the accuracy of lip-sync (e.g., synchronization timing), it is desirable to perform the lip-sync processing based on synthesized speech data. Thus, in this embodiment, above-described uLipsync, which analyzes speech data and performs lip-sync processing, is used. In this case, for example, in iOS, the write (_:toBufferCallback:) method of the Speech synthesis framework is usually used to output synthesized speech data to an audio file. In this case, in controlling the avatar, the control unit 2 operates Unity to play back speech using the audio file (e.g., in .WAV format) containing the output synthesized speech data.

However, in iOS17, which is available at the time of filing of this application, it may not be possible to output speech data synthesized using a voice model of a user created by machine learning with the Personal Voice function (Personal Voice) to an audio file using the write( ) method. That is, probably due to Apple® Inc.'s policy, it may not be possible to generate an audio file from synthesized speech data created using Personal Voice in ios17 available at the time of filing of this application. In this case, therefore, lip-sync processing by uLipsync cannot be performed, and an alternative method is required for this purpose.

In this embodiment, as a possible solution, the speak (_:) method of the AVSpeechSynthesizer class in iOS is used to read the text data of the result of translation received in step S5 as described above, and change the mouth movements of the avatar using information on “characters to be read” at the time of reading. Specifically, the information on “characters to be read (unit: words)” can be obtained by defining AVSpeechSynthesizerDelegate functions in the same class in iOS and using one of those functions, which is defined, for example, as follows:

```
speechSynthesizer(_ synthesizer: AVSpeechSynthesizer,
  willSpeakRangeOfSpeechString characterRange: NSRange,
  utterance: AVSpeechUtterance)
{
  let readingUtteranceString = (
    utterance.speechString as NSString).substring(with:
characterRange)
}
```

In this example, the information on “characters to be read” is obtained using readingUtteranceString.

Next, the obtained information on characters to be read is converted into the International Phonetic Alphabet (IPA), which is a phoneme-like notation. To do this, for example, to convert English words (US) to the IPA, English-to-IPA, a program on GitHub available from the following URL, can be used.

https://github.com/mphilli/English-to-IPA

Then, viseme IDs are obtained from the converted IPA data. This obtaining can be done, for example, based on a correspondence table between the IPA and the viseme IDs created in advance.

Then, at a predetermined interval, for each IPA phoneme, the mouth movements of the avatar are changed to form the mouth shape indicated by a viseme ID.

A Unity plug-in or asset is created to execute the above processing.

In the above-described method, the interval between the IPA phonemes is set to a fixed value (e.g., 200 ms) because the duration of each phoneme and the entire time required to utter each word on the utterance time axis are not known. To improve the lip-sync accuracy, this interval may be calculated using a correction method such as weighting (e.g., multiplying by 0.7 or 1.1) the fixed value to vary the interval according to the IPA phonemes.

After the above processing, the control unit 2 proceeds to step S10.

In step S9, the control unit 2 plays back the speech data of the synthesis result received via the API by the sound input/output unit 6 and outputs the speech from the speaker. When the above-described function to play back the translated words in a voice similar to the use's own voice (using the speech synthesis function provided by the mobile terminal itself, for example, the speech synthesis function of iOS) is used, the speak (_:) method of the AVSpeechSynthesizer class in iOS can be used to play back the synthesized speech in a voice similar to the use's own voice. When the control unit 2 displays on the display unit 7 the text data the result of translation into the other language received from the translation front-end server 54 via the proprietary API in step S5 as described above.

In step S10, the control unit 2 determines whether a termination event is received or not. The termination event is issued by the OS when the user exits the running speech translation program, for example, by swiping the screen of the mobile terminal. If the termination event is received, the control unit 2 terminates the speech translation program (Yes branch). Otherwise, if the termination event is not received, the control unit 2 proceeds to step S3 to continue the above process of the speech translation program (No branch).

The above is a description of the speech translation process performed by the speech translation program in this embodiment.

The speech translation program in this embodiment has the above-mentioned function to speak by playing back translated words in a voice that resembles user's own voice as one way of facilitating communication between people having a conversation. When this function is used, the speech synthesis module 33 of the speech translation program performs speech synthesis so as to utter translated words (text) in a voice that resembles user's own voice using a voice model of the user that learned (machine-learned) characteristics of the voice of the user reading given sentences in advance. In this case, when synthesized speech data is played back, translated words are played back in a voice that resembles the voice of a user who is the speaker, which reduces the possibility that a hearer feels odd during a conversation due to the difference between the speaker's own voice that is heard directly by the hearer and the voice produced by the mobile terminal 1.

When user's voice is learned (machine-learned) in advance by reading given “sentences” in this way, not only characters and words, but also accents and intonations can be learned by combining acoustic characteristics. Consequently, by using a voice model created by this learning, speech synthesis can be performed so as to utter translated words (text) in a relatively natural voice.

Thus, the speech translation program in this embodiment makes it possible to talk to a person with whom a conversation is held through the speech translation program about something to talk more about or ask more about, without limiting the conversation to a simple one, for example, including just a single question. This helps to keep the conversation going and make the conversation lively, thereby facilitating communication among those having the conversation.

The speech translation program in this embodiment has the above-mentioned function to display an avatar as one way of facilitating communication between people having a conversation. When the function is used, the avatar control module 34 of the speech translation program displays an avatar on the display unit 7 of the mobile terminal 1 during a conversation, and changes the mouth movements of the avatar to match the timing of speech by playing back translated words and to conform the mouth shape to the content of the speech.

By the way, recently, theme songs from Japanese animation (anime) have topped the U.S. Billboard charts, trading cards with designs and photos of anime characters printed thereon have been traded at high prices internationally, and foreigners dressing up as anime characters have increased. Also, in recent years, it has become commonplace to use fictional or animated characters as avatars in virtual reality, the Metaverse, and for virtual YouTubers. Furthermore, it can be clearly seen from TV, Internet news, and the like, that in recent years, Japanese animation has been familiar and loved by people in various countries including Europe, the U.S., and Asia. These facts indicate that communication through avatars of fictional or animated characters certainly increases the chances of having lively conversations thanks to the avatars and thus keeping the conversation going.

Accordingly, the speech translation program in this embodiment makes conversations lively through communication using avatars without limiting the conversations to simple ones, for example, including just a single question, thereby facilitating communication among those having the conversations.

In the above description, an avatar is displayed on the screen of the display unit 7 according to options selected by a user, and the user can select the avatar from among multiple avatars, for example, in the settings screen. In the speech translation program according to the present invention, model data for the avatar is usually stored in advance (preset) in the storage unit 3 of the mobile terminal 1. However, this model data may also be imported externally to the mobile terminal 1 via the wireless communication unit 4 or I/O port 13. In this case, the user can externally import model data that the user wants to use, for example, by operating the model data acquisition screen that is separately provided for such import.

Although not explained above, the speech translation program according to the present invention can also generate model data for an avatar on the mobile terminal 1 and display an avatar of that model on the screen using the generated model data. In this case, the avatar control module 34 generates model data with the use of a software development kit (SDK) provided by MotionPortrait, Inc. to utilize the company's MotionPortrait® technology. Specifically, by using a library in the SDK, from an image taken by a user using the camera unit 10 of the mobile terminal 1, the avatar control module 34 generates model data for an avatar based on the subject (such as a real or illustrated person and animal) of the image. An image imported externally to the mobile terminal 1 via the wireless communication unit 4 or I/O port 13 may also be used for the generation. The avatar control module 34 then uses the library to display an avatar using the generated model data on the screen of the display unit 7, and controls the movements of the head, eyes, and mouth, the facial expressions, etc. of the avatar. In this case, in particular, lip-sync control between the mouth movements of the avatar and reading of words is performed using the lip-sync function in the library instead of the Unity plug-in uLipsync mentioned above.

In the above description, the speech translation program according to the present invention is installed and operated on a portable information terminal, such as a smartphone, that can be carried around. It goes without saying that the speech translation program according to the present invention can also be operated on other common computers, such as tablet, notebook, and desktop (tower) PCs. However, considering that the speech translation program according to the present invention may be used, for example, during overseas travel, it is preferable to install and operate the speech translation program on a portable information terminal (mobile terminal) such as a smartphone.
1 Mobile terminal (portable information terminal)
2 Control unit
3 Storage unit
4 Wireless communication unit (external communication unit)
5 Baseband processing unit
6 Sound input/output unit
7 Display unit
8 Operation unit
13 I/O port (external communication unit)
31 Speech recognition module
32 Translation module
33 Speech synthesis module
34 Avatar control module
51 Base station
52 Internet
53 Speech recognition server
54 Translation front-end server
55 Translation server(s)
56 Speech synthesis server

Although the present invention has been described with reference to preferred embodiments, workers skilled in the art will recognize that changes may be made in form and detail without departing from the spirit and scope of the invention.

1. A storage medium storing a speech translation program executed on a portable information terminal, wherein
the speech translation program causes a control unit of the information terminal to execute steps of:
recognizing inputted speaker's speech and outputting information on a recognition result;
translating a language spoken by the speaker into another language based on the output information on the recognition result, and outputting information on a result of translation;
performing speech synthesis of words in the other language based on the output information on the result of translation in a way that enables the words to be played back in a voice that resembles the speaker's own voice; and
playing back the words in the other language in the voice that resembles the speaker's own voice by the speech synthesis.

2. The storage medium storing a speech translation program according to claim 1, wherein
the speech translation program causes the control unit of the information terminal to execute steps of:
creating a voice model for the speaker on the information terminal by displaying given sentences on a display unit of the information terminal and machine-learning characteristics of the speaker's voice in which the sentences are read; and
performing the speech synthesis using the voice model on the information terminal.

3. The storage medium storing a speech translation program according to claim 1, wherein
the speech translation program causes the control unit of the information terminal to execute steps of:
displaying an avatar on a display unit of the information terminal; and
changing mouth movements of the avatar to match timing of speech by playing back the words and to conform mouth shape to content of the speech.

4. The storage medium storing a speech translation program according to claim 3, wherein
the speech translation program uses model data of the avatar generated based on a subject in an image taken by a camera unit of the information terminal or in an image imported externally to the information terminal via an external communication unit of the information terminal as model data of the avatar.

5. The storage medium storing a speech translation program according to claim 4, wherein
translating into the other language is performed by using one or more cloud services via an external server, and
the speech translation program causes the control unit of the information terminal to execute steps of:
when the speaker specifies information regarding a specified provider that specifies one of the cloud services to be used, requesting the translation by passing the information regarding the specified provider to the server; and
receiving, from the server, information on the translation into the other language obtained by using the cloud service specified in the information regarding the specified provider, and outputting the received information on the translation into the other language as the information on the result of translation.

6. The storage medium storing a speech translation program according to claim 4, wherein
translating into the other language is performed by using one or more cloud services via an external server, and
the speech translation program causes the control unit of the information terminal to execute steps of:
when the speaker does not specify information regarding a specified provider that specifies one of the cloud services to be used, requesting the translation by passing, as the information regarding the specified provider, information indicating that none of the cloud services is specified to the server; and
receiving, from the server, information on the translation into the other language obtained from a cloud service that returns information on the translation into the other language first among all the cloud services, and outputting the received information on the translation as the information on the result of translation.

7. The storage medium storing a speech translation program according to claim 2, wherein
the speech translation program causes the control unit of the information terminal to execute steps of:
displaying an avatar on a display unit of the information terminal; and
changing mouth movements of the avatar to match timing of speech by playing back the words and to conform mouth shape to content of the speech.

8. The storage medium storing a speech translation program according to claim 7, wherein
the speech translation program uses model data of the avatar generated based on a subject in an image taken by a camera unit of the information terminal or in an image imported externally to the information terminal via an external communication unit of the information terminal as model data of the avatar.

9. The storage medium storing a speech translation program according to claim 8, wherein
translating into the other language is performed by using one or more cloud services via an external server, and
the speech translation program causes the control unit of the information terminal to execute steps of:
when the speaker specifies information regarding a specified provider that specifies one of the cloud services to be used, requesting the translation by passing the information regarding the specified provider to the server; and
receiving, from the server, information on the translation into the other language obtained by using the cloud service specified in the information regarding the specified provider, and outputting the received information on the translation into the other language as the information on the result of translation.

10. The storage medium storing a speech translation program according to claim 8, wherein
translating into the other language is performed by using one or more cloud services via an external server, and
the speech translation program causes the control unit of the information terminal to execute steps of:
when the speaker does not specify information regarding a specified provider that specifies one of the cloud services to be used, requesting the translation by passing, as the information regarding the specified provider, information indicating that none of the cloud services is specified to the server; and
receiving, from the server, information on the translation into the other language obtained from a cloud service that returns information on the translation into the other language first among all the cloud services, and outputting the received information on the translation as the information on the result of translation.
